(19) United States
(12) Patent Application Publication
(10) Pub. No.: US 2008/0074576 A1
(43) Pub. Date: Mar. 27, 2008

(54) BACKLIGHT UNIT, LIQUID CRYSTAL DISPLAY HAVING THE SAME, AND A METHOD OF ASSEMBLING THE BACKLIGHT UNIT

(75) Inventors: Joo-woan CHO, Seoul (KR); Seong-sik CHOI, Seoul (KR); Du-hwan CHUNG, Suwon-si (KR); Dong-hoon KIM, Seoul (KR); Tae-seok JANG, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/855,397

(22) Filed: Sep. 14, 2007

(30) Foreign Application Priority Data
Sep. 22, 2006 (KR) 10-2006-0092370

(51) Int. Cl. G02F 1/1333; F21S 4/00

(52) U.S. Cl. 349/58; 362/225

(57) ABSTRACT

A liquid crystal display device includes a liquid crystal panel, a light source unit, a socket unit into which an end portion of the light source unit is inserted, and an accommodation casing accommodating the light source unit and the socket unit. The socket unit includes a clamp supports the light source unit, a socket main body coupled to the accommodation casing and including insertion holes accommodating the clamp, and a coupling protrusion. The socket unit also includes a socket locker including an opening unit providing an insertion position into which the coupling protrusion is inserted, and a coupling position into which the socket locker is coupled to the socket main body.

This application claims priority to Korean Patent Application No. 2006-0092370, filed on Sep. 22, 2006, and all the benefits accruing therefrom under 35 U.S.C. 119, the contents of which in its entirety are incorporated by reference.

### BACKGROUND OF INVENTION

1. Field of Invention

The present invention relates generally to a backlight unit and a liquid crystal display device having the same, and more particularly, to a backlight unit with an improved structure for assembly and assembling stability, a liquid crystal display device having the same, and a method of assembling the backlight unit.

2. Description of the Related Art

There has been increasing use of slim and lightweight liquid crystal display (“LCD”) devices, which have replaced conventional cathode ray tube display devices. An LCD device includes a liquid crystal panel, a backlight unit provided behind the liquid crystal panel, a cover, and an accommodation casing that are coupled to each other and support the liquid crystal panel and the backlight unit.

The backlight unit, which emits light toward a rear surface of the liquid crystal panel, includes a light source unit that emits light, an optical member that is provided between the liquid crystal panel and the light source unit, and an inverter that supplies power to the light source. The light source unit is generally coupled to the inverter through a cable.

However, upon coupling the light source unit to the inverter with the cable, a coupled portion between the cable and the light source or between the cable and the inverter may be easily affected by an external impact. That is, the coupling is oftentimes short-circuited. Further, since the cable is supported in a desired location using a soldering method, the cable may not be stably assembled.

### BRIEF SUMMARY OF THE INVENTION

Accordingly, it is an aspect of the present invention to provide a backlight unit with an improved assembly and assembling stability, a liquid crystal display device having the same, and a method of assembling the backlight unit.

Additional aspects of the present invention will be set forth in part in the description which follows and, in part, will be obvious from the description, or may be learned by practice of the present invention.

An exemplary embodiment of the present invention includes a liquid crystal display device including a liquid crystal panel, a light source unit disposed behind the liquid crystal panel, a socket unit into which an end portion of the light source unit is inserted, and an accommodation casing accommodating the light source unit and the socket unit. The socket unit includes a clamp that includes a light source support unit supporting a light source electrode of the light source unit and a socket main body coupled to the accommodation casing. The socket main body includes a plurality of insertion holes accommodating the clamp and a coupling protrusion provided on a surface of the socket main body facing the liquid crystal panel and located between the insertion holes. The socket main body also includes and a socket locker including an opening unit that provides an insertion position defined by a first opening in the opening unit into which the coupling protrusion is inserted, and a coupling position defined by a second opening in the opening unit that is narrower than the first opening and by which the socket locker is coupled to the socket main body. The socket locker is coupled to the socket main body by sliding the socket locker in a horizontal direction toward the second opening of the opening unit and away from the insertion position until the coupling protrusion rests on a portion of the second opening.

The clamp may include an inverter coupling unit extending from the light source support unit and disposed in the insertion hole facing the accommodation casing.

The inverter coupling unit may have an ‘L’ shape.

The liquid crystal display device may further include an inverter disposed behind the accommodation casing. The inverter coupling unit may be coupled to the inverter.

The inverter may include a contact unit protruded therefrom and contacting the inverter coupling unit. The contact unit may be inserted between the inverter coupling unit and a rear surface of the socket main body.

The liquid crystal display device may further include a case covering the inverter coupling unit and the contact unit. The case may include an opening formed on a region thereof into which the contact unit is inserted.

The socket main body may further include a hook unit disposed on a surface facing the accommodation casing and located between the insertion holes.

The accommodation casing may include a coupling hole coupled to the hook unit, and a coupling unit disclosure hole disclosing a portion of the inverter coupling unit when the accommodation casing is coupled to the hook unit.

The coupling protrusion of the socket main body may have a ‘T’ shape.

The opening unit of the socket locker may have a ‘T’ shape when viewed from a sliding direction.

The liquid crystal display device may further include a side mold disposed between the liquid crystal panel and the socket unit and covering the socket unit. The side mold may include a support protrusion inserted into the opening unit in the coupling position and supporting the coupling protrusion of the socket locker.

The support protrusion may press the coupling protrusion in an opposite direction of a sliding direction of the socket locker in the coupling position, and prevent the light source unit from being separated from the light source support unit.

The side mold may include an accommodation hole into which an end portion of the light source unit is accommodated.

The light source unit may include at least one of a cold cathode fluorescent lamp, an external electrode fluorescent lamp, and a hot cathode fluorescent lamp.

In a further exemplary embodiment, a backlight unit is provided. The backlight unit includes a light source unit, a socket unit into which an end portion of the light source unit is inserted, and an inverter supplying power to the light source unit through the socket unit. The socket unit includes a plurality of clamps that include light source support units supporting a light source electrode of the light source unit, and a socket main body including a plurality of insertion holes into which the respective clamps are inserted. The socket main body extends lengthwise along an end portion of the light source unit. The socket unit also includes a socket locker extending parallel with the socket main body. The socket locker is coupled to the socket main body, preventing the light source unit from moving in an inserting direction of the clamps.

The socket main body may further include a coupling protrusion disposed between the insertion holes. The socket locker may include an opening unit that provides an insertion position defined by a first opening in the opening unit into which the coupling protrusion is inserted, and a coupling position defined by a second opening in the opening unit that is narrower than the first opening and by which the socket locker is coupled to the socket main body. The socket locker is coupled to the socket main body by sliding the socket locker in a horizontal direction toward the second opening of the opening unit and away from the insertion position until the coupling protrusion rests on a portion of the second opening.

The clamp may further include an inverter coupling unit extending from the light source support unit and disposed in the insertion hole facing the accommodation casing.

The inverter coupling unit may have an ‘L’ shape.

The inverter may include a contact unit protruding therefrom and contacting the inverter coupling unit. The contact unit may be inserted between the inverter coupling unit and the socket main body.

The coupling protrusion of the socket main body may have a ‘T’ shape.

The opening unit of the socket locker may have a ‘T’ shape when viewed from a sliding direction.

The light source unit may include at least one of a cold cathode fluorescent lamp, an external electrode fluorescent lamp, and a hot cathode fluorescent lamp.

A further exemplary embodiment includes a method for assembling a backlight assembly with improved assembling stability. The method includes inserting an end portion of a light source unit into a socket unit. The socket unit includes a plurality of clamps including light source support units for supporting light source electrodes of the light source unit. The backlight assembly also includes a socket main body and a socket locker. The method also includes inserting the clamps into respective plurality of insertion holes on the socket main body. The socket main body extends lengthwise along an end portion of the light source unit. The method further includes coupling the socket locker with the socket main body. The socket locker extends parallel with the socket main body and prevents the light source unit from moving in an inserting direction of the clamps.

The socket main body may also include a coupling protrusion disposed between the insertion holes, and the socket locker may include an opening unit that provides an insertion position defined by a first opening in the opening unit into which the coupling protrusion is inserted, and a coupling position defined by a second opening in the opening unit that is narrower than the first opening and by which the socket locker is coupled to the socket main body. The socket locker may be coupled to the socket main body by sliding the socket locker in a horizontal direction toward the second opening of the opening unit and away from the insertion position until the coupling protrusion rests on a portion of the second opening.

The clamp may also include an inverter coupling unit extending from the light source support unit and disposed in the insertion hole facing the accommodation casing.

The inverter coupling unit may have an ‘L’ shape.

The inverter may include a contact unit protruded therefrom and contacting the inverter coupling unit. The method may further include inserting the contact unit between the inverter coupling unit and the socket main body.

The coupling protrusion of the socket main body may have a ‘T’ shape.

The opening unit of the socket locker may have a ‘T’ shape when viewed from a sliding position.

The light source unit may include at least one of a cold cathode fluorescent lamp, an external electrode fluorescent lamp, and a hot cathode fluorescent lamp.

### BRIEF DESCRIPTION OF THE DRAWINGS

The above and/or other aspects, features, and advantages of the present invention will become apparent and more readily appreciated from the following description of the exemplary embodiments, taken in conjunction with the accompanying drawings, in which:

FIG. 1 is an exploded perspective view illustrating an LCD device according to an exemplary embodiment of the present invention;

FIG. 2 is a partial exploded perspective view illustrating an LCD device according to an exemplary embodiment of the present invention;

FIG. 3 is a partial exploded perspective view illustrating a coupling between a socket unit and a side mold according to an exemplary embodiment of the present invention;

FIG. 4 is a partial exploded perspective view illustrating a coupling between the socket unit and a clamp according to an exemplary embodiment of the present invention;

FIGS. 5 and 6 are diagrams illustrating a coupling between the socket unit main body and a socket locker according to an exemplary embodiment of the present invention;

FIG. 7 is a diagram illustrating a coupling between the clamp and an inverter according to an exemplary embodiment of the present invention; and

FIGS. 8 through 15 are diagrams successively illustrating a method of assembling a backlight unit according to an exemplary embodiment of the present invention.

### DETAILED DESCRIPTION OF THE INVENTION

Reference will now be made in detail to exemplary embodiments of the present invention, examples of which are illustrated in the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art.

A same reference number is allocated to a same element for different embodiments. The same element may be representatively explained only in a first embodiment and omitted in subsequent embodiments.

If a first film (layer) or element is ‘on’ a second film (layer) or element, third films (layers) or elements may be interposed between the first and the second films (layers) or elements or the first and the second films (layers) or elements may contact directly. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

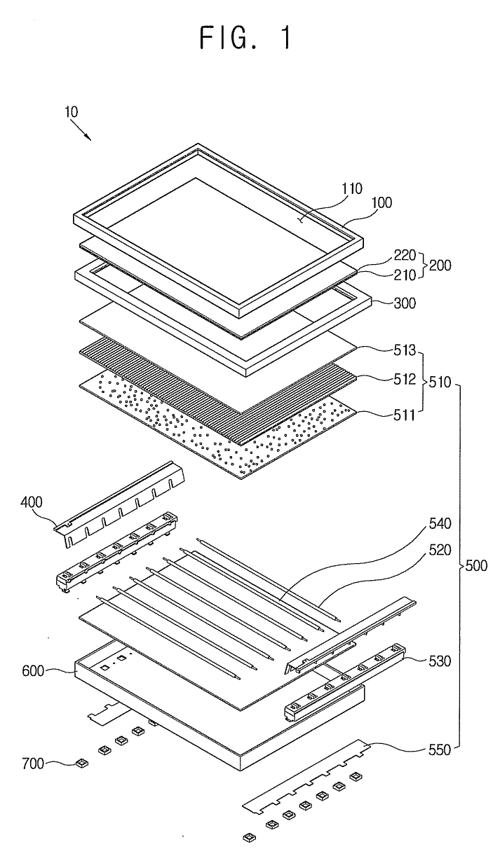

A liquid crystal display (“LCD”) device 10, as illustrated in FIG. 1, includes a liquid crystal panel 200 that generates an image, a backlight unit 500 that supplies light to a rear side of the liquid crystal panel 200, a mold frame 300 that supports the liquid crystal panel 200, a cover 100 that discloses a display area of the liquid crystal panel 200, and an accommodation casing 600 that accommodates the liquid crystal panel 200, etc. therein.

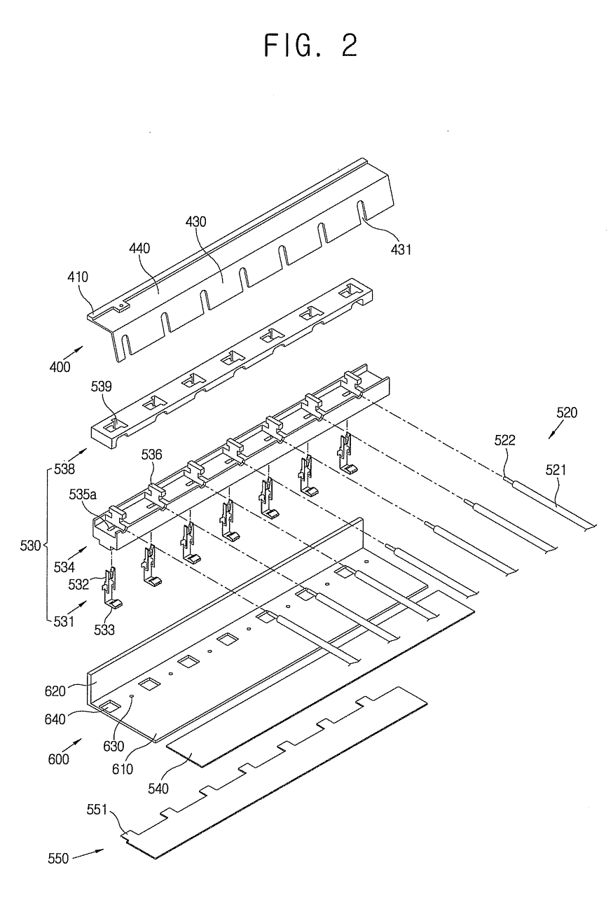

As illustrated in FIGS. 1 and 2, the backlight unit 500 includes a light source unit 520, an optical member 510 disposed between the liquid crystal panel 200 and the light source unit 520, a reflection sheet 540 disposed between the accommodation casing 600 and the light source unit 520, an inverter 550 that supplies power to the light source unit 520, and a socket unit 530 that couples the inverter 550 with the light source unit 520.

The cover 100 includes a display window 110 that discloses a display area of the liquid crystal panel 200. Further, the cover 100 covers an edge portion of the liquid crystal panel 200. The cover 100, which is coupled to the accommodation casing 600, accommodates the liquid crystal panel 200.

The liquid crystal panel 200 includes a first substrate 210 having a thin film transistor (“TFT”) formed thereon, a second substrate 220 facing the first substrate 210, and a liquid crystal layer (not shown) disposed therebetween. A liquid crystal cell as a pixel unit is arranged in a matrix form in the liquid crystal panel 200. An image is formed by adjusting the light transmittance of the liquid crystal cell according to image signal information transmitted from a drive element (not shown).

The mold frame 300 has a substantially square shape and supports the liquid crystal panel 200 at its outer edges. The mold frame 300 may be formed from a plastic material.

A pair of side molds 400 is disposed behind the mold frame 300. The side molds 400 are disposed at opposite ends of the light source unit 520, and support the mold frame 300, as well as corresponding end portions of the optical member 510.

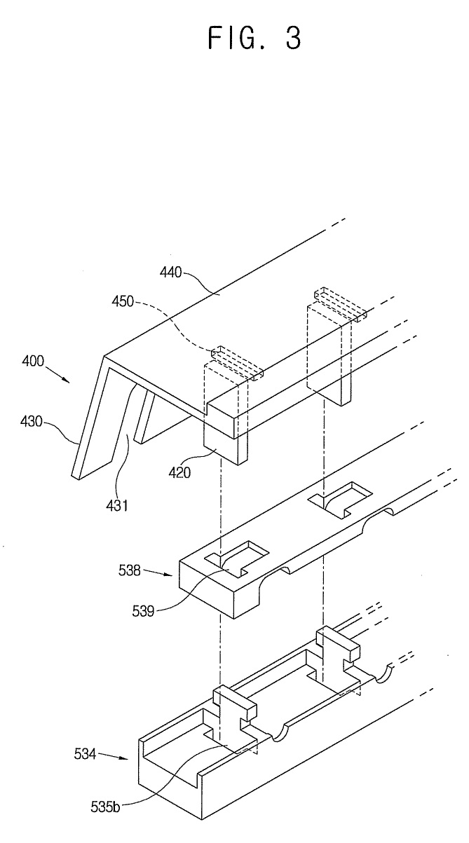

As illustrated in FIGS. 2 and 3, each of the side molds 400 includes a main body unit 410 that supports the mold frame 300, a support protrusion 420 that extends toward the accommodation casing 600, a reflection unit 430 that extends downwardly at a predetermined angle, and a support surface 440 that couples the main body unit 410 with the reflection unit 430 and supports an outer edge portion of the optical member 510. As illustrated in FIG. 3, the support surface 440 includes a coupling protrusion insertion hole 450 into which a coupling protrusion 536 of a socket main body 534 is partially inserted when the socket unit 530 is coupled to the side mold 400.

The main body unit 410 of each of the side molds 400 is disposed along two opposing sidewalls 620 of the accommodation casing 600 that extend parallel with the light source unit 520.

As illustrated in FIG. 3, the support protrusion 420 is inserted into an opening unit 539 provided in a socket locker 538 and a first insertion hole 535b of the socket main body 534, and supports the coupling protrusion 536 of the socket main body 534. The support and coupling of the support protrusion 420 and the socket unit 530 will be described in detail further herein.

The reflection unit 430 reflects light emitted from the light source unit 520 to the optical member 510, thereby improving the light efficiency. A reflection layer (not shown) may be formed on a surface of the reflection unit 430 facing the liquid crystal panel 200. The reflection unit 430 includes an accommodation hole 431 into which a portion of the light source unit 520 is inserted.

The support surface 440, which supports an edge portion of the optical member 510, is formed on a lower portion of a stepped area of the main body unit 410. The support surface 440 includes the coupling protrusion insertion hole 450 formed on a surface thereof. The coupling protrusion 536 of the socket main body 534 is partially inserted into the coupling protrusion insertion hole 450 when the socket unit 530 is coupled to the side mold 400. Further, the coupling protrusion insertion hole 450 is formed at a location corresponding to the coupling protrusion 536 of the socket main body 534 when the socket main body 534 and the socket locker 538 are in the coupling position.

The backlight unit 500 includes the optical member 510 disposed behind the liquid crystal panel 200, the light source unit 520 disposed behind the optical member 510, the socket unit 530 into which an end portion of the light source unit 520 is inserted, the reflection sheet 540 disposed between the light source unit 520 and the accommodation casing 600, and the inverter 550 disposed behind the accommodation casing 600.

The optical member 510 includes a diffusion plate 511, a prism sheet 512, and a passivation sheet 513.

The diffusion plate 511 diffuses the light emitted from the light source unit 520 and supplies the diffused light to the liquid crystal panel 200. The diffusion plate 511 may have a relatively thick thickness.

A prism having a triangular column shape is formed in an arrangement on an upper part of the prism sheet 512.

The prism sheet 512 gathers the light diffused through the diffusion sheet 511 such that the light advances vertically toward the surface of the liquid crystal panel 200. For example, two prism sheets 512 may be provided, and a micro prism having a predetermined angle is formed on the respective prism sheet 512. A light passing through the prism sheet 512 straightly advances in a vertical direction toward the surface of the liquid crystal panel 100. As a result, most of the light passing through the prism sheet 512 advances vertically and provides a uniform distribution of luminance.

The passivation sheet 513, which is disposed on a top region of the backlight unit 500, may protect the prism sheet 512 from being easily scratched.

The light source unit 520 includes a light source main body 521 that emits light, and a light source electrode 522 disposed at an end portion of the light source main body 521. The light source unit 520 is driven by power supplied from the inverter 550 through the socket unit 530. The light source unit 520 extends lengthwise along a side of the liquid crystal panel 200, and each of the light source main bodies 521 are extended in parallel with each other.

The light source unit 520 may employ a cold cathode fluorescent lamp (“CCFL”). Alternatively, the light source unit 520 may employ an external electrode fluorescent lamp (“EEFL”) having a high luminance, low cost, and low power consumption capable of driving the light source unit 430 with one inverter (not shown). Alternatively, a hot cathode fluorescent lamp (“HCFL”) having a high luminance may be employed.

As illustrated in FIG. 2, the socket unit 530 includes a clamp 531 that couples the light source unit 520 with the inverter 550, the socket main body 534 into which the clamp 531 is inserted, and the socket locker 538 that is coupled to the socket main body 534, and stably supports a coupling between the light source unit 520 and the clamp 531.

As illustrated in FIGS. 2 and 3, the clamp 531 includes a light source support unit 532 that supports the light source electrode 522 of the light source unit 520, and an inverter coupling unit 533 that extends from the light source support unit 532 and contacts the inverter 550. The clamp 531 includes a metal or a conductive material.

The light source support unit 532 may be formed of a pair of conducting plates and includes a seating hole or groove that receives and seats the light source electrode 522 by bending the conductive plates. The pair of conducting plates is coupled to opposite sides of the inverter coupling unit 533.

The inverter coupling unit 533 also includes a conductive plate having a ‘L’ shape and is coupled to the inverter 550. The clamp 531 electrically couples the light source unit 520 with the inverter 550.

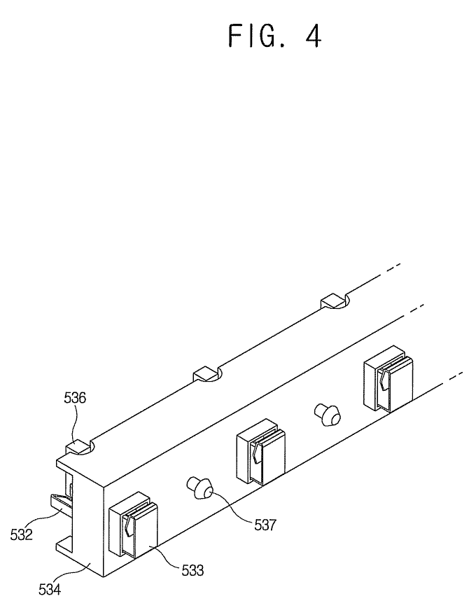

As illustrated in FIG. 2, a cross-view of the socket main body 534 has a substantially square shape. The socket main body 534 also has a columnar shape when viewed in a lengthwise direction. The socket main body 534 includes a plurality of second insertion holes 535a, the coupling protrusion 536 disposed between the second insertion holes 535a facing the liquid crystal panel 200, and a hook unit 537 (shown in FIG. 4) provided between the second insertion holes 535a facing the accommodation casing 600. Hereinafter, in the socket main body 534, a surface having the coupling protrusion 536 disposed thereon will be referred to as a front surface, and another surface having the hook unit 537 disposed thereon will be referred to as a rear surface. As illustrated above, the second insertion holes 535a and the first insertion holes 535b are formed in the front surface. The coupling protrusion 536 is disposed between the first insertion holes 535b and the second insertion holes 535a.

The second insertion holes 535a are spaced from each other at a regular distance. As illustrated in FIG. 2, each second insertion hole 535a accommodates the clamp 531. The second insertion holes 535a are provided so that the clamps 531 can pass through the second insertion holes 535a. When the clamp 531 and the second insertion holes 535a are coupled, the light source support unit 532 of the clamp 531 is disposed in a front direction of the socket main body 534 (i.e., front surface). Further, the inverter coupling unit 533 of the clamp 531 is disposed in a rear direction of the socket main body 534 (i.e., rear surface).

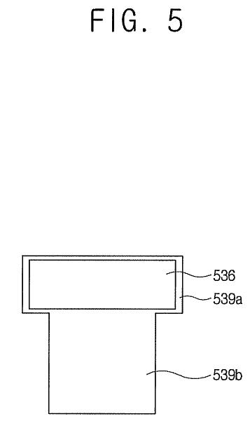

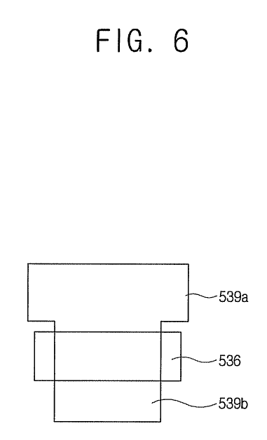

As illustrated in FIG. 2, the coupling protrusion 536 is disposed in the front surface of the socket main body 534 between insertion holes 535. The coupling protrusion 536 may have a ‘T’ shape, and extends in a direction toward the liquid crystal panel 200. An insertion position (shown in FIG. 5) and a coupling position (shown in FIG. 6) are implemented through an interaction between the coupling protrusion 536 and the opening unit 539 of the socket locker 538.

The hook unit 537 is coupled to a coupling hole 630 of the accommodation casing 600 so that the socket unit 530 can be coupled to the accommodation casing 600.

As illustrated in FIG. 2, the socket locker 538 covers the front surface of the socket main body 534. The socket locker 538 includes a plurality of opening units 539 that receive the coupling protrusion 536. The opening units 539 may have a ‘T’ shape. The insertion position (shown in FIG. 5) and the coupling position (shown in FIG. 6) are implemented through an interaction between the coupling protrusion 536 and the opening unit 539.

The insertion position indicates a position defined by a first opening in the opening unit (i.e., opening unit 539a) in which the coupling protrusion 536 is inserted. The first opening unit 539a has a wider width than a width of a second opening unit 539b and the coupling protrusion, thereby allowing an up and down reciprocating movement of the socket locker 538 from the socket main body 534, as illustrated in FIG. 5.

The coupling position indicates a position defined by the second opening (i.e., opening unit 539b) in the opening unit in which the socket locker 538 is coupled to the socket main body 534. The socket locker 538 is coupled to the socket main body 534 by sliding the socket locker 538 in a horizontal direction toward the second opening 539b of the opening unit 539 and away from the insertion position until the coupling protrusion 536 rests on a portion of the second opening 539b of the opening unit 539. FIG. 6 illustrates the coupling position. A head portion of the coupling protrusion 536 in the coupling position is located in a second opening unit 539b having a narrower width than the first opening unit 539a. In this coupling position, the up and down reciprocating movement of the socket locker 538 from the socket main body 534 is restricted.

The reflection sheet 540, which is disposed between the light source unit 520 and the accommodation casing 600, reflects the light emitted from the light source unit 520 toward the diffusion plate 511. The reflection sheet 540 may includes polyethylenterephthalate (“PET”) and polycarbonate (“PC”) or the like.

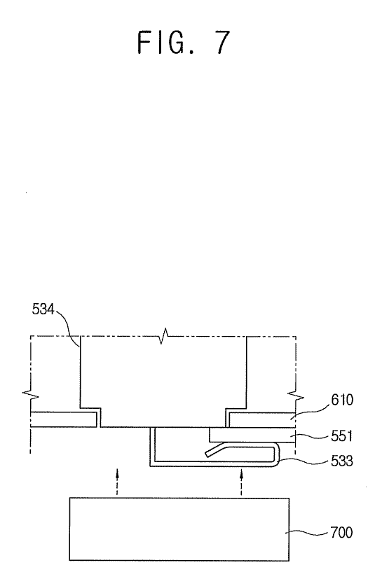

As illustrated in FIG. 2, the inverter 550 is disposed behind the accommodation casing 600. For example, the pair of inverters 550 may be disposed at opposite ends of the light source unit 520. The inverter 550, as a power supply that supplies power to the light source unit 520, includes an inverter circuit board having a plurality of circuit elements mounted thereon. Further, the inverter 550 includes a contact unit 551 that protrudes therefrom and is formed on one edge of the inverter 550. The contact unit 551 contacts the inverter coupling unit 533, and is inserted between the inverter coupling unit 533 and the rear surface of the socket main body 534 as illustrated in FIG. 7.

The accommodation casing 600 includes a bottom unit 610 and a sidewall 620 that upwardly extends from a side of the bottom unit 610. As illustrated in FIG. 2, a region of the bottom unit 610 corresponding to opposite ends of the light source unit 520 includes the coupling holes 630 that are coupled to the hook units 537 of the socket main body 534, and a coupling unit disclosure hole 640 that receives the inverter coupling unit 533 of the clamp 531.

A case 700 that covers the inverter coupling unit 533 and the contact unit 551 is disposed behind the accommodation casing 600 corresponding to the coupling unit disclosure hole 640. The inverter coupling unit 533 and the contact unit 551 may be formed from an electrical conductive material. Further, the inverter coupling part 533 and the contact unit 551 may be insulated from other elements.

The case 700 may be formed from an insulation material to insulate the inverter coupling part 533 and the contact unit 551 from other elements. Further, a press member (not shown) such as a protrusion may be provided in the case 700 to make a stable contact between the inverter coupling unit 533 and the contact unit 551.

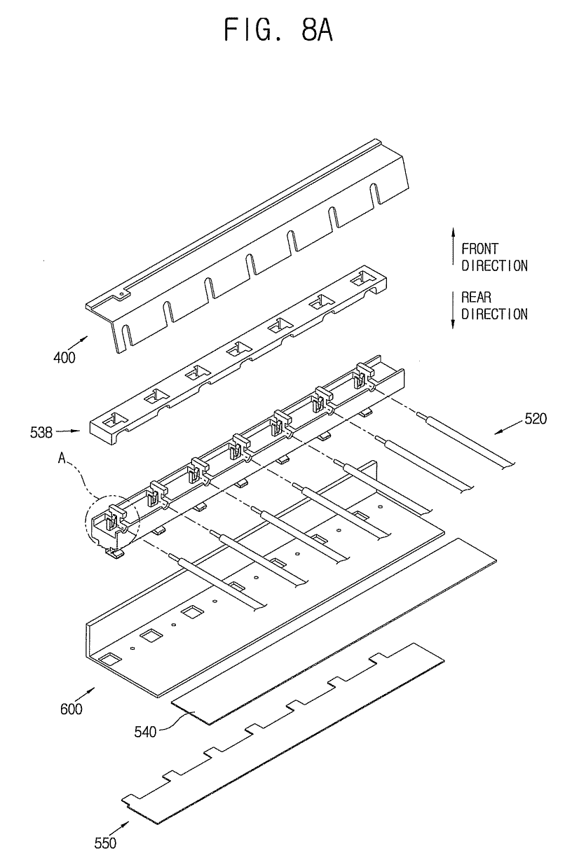

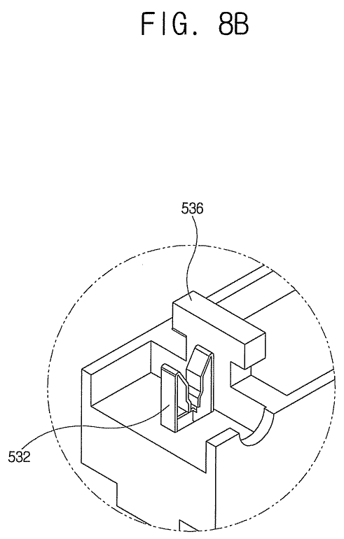

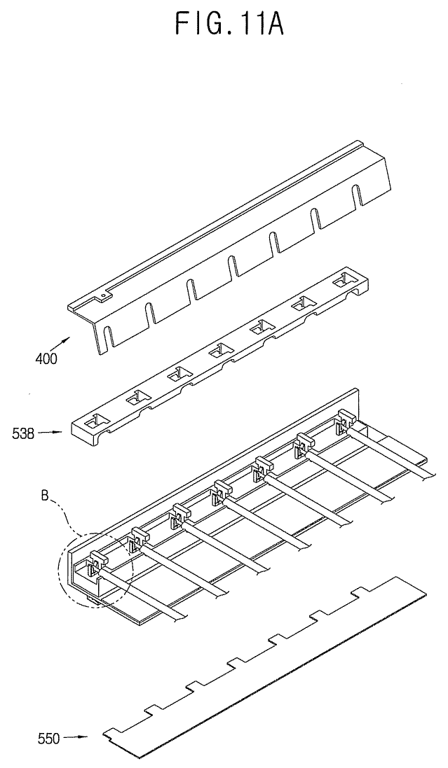

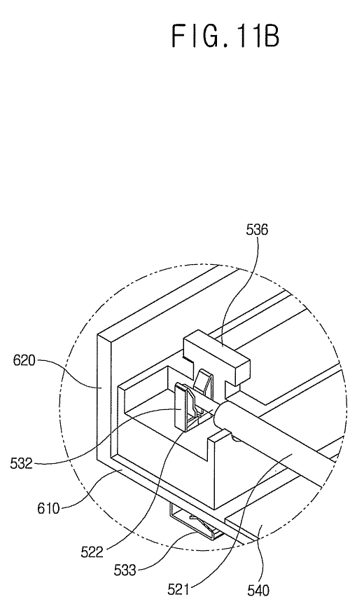

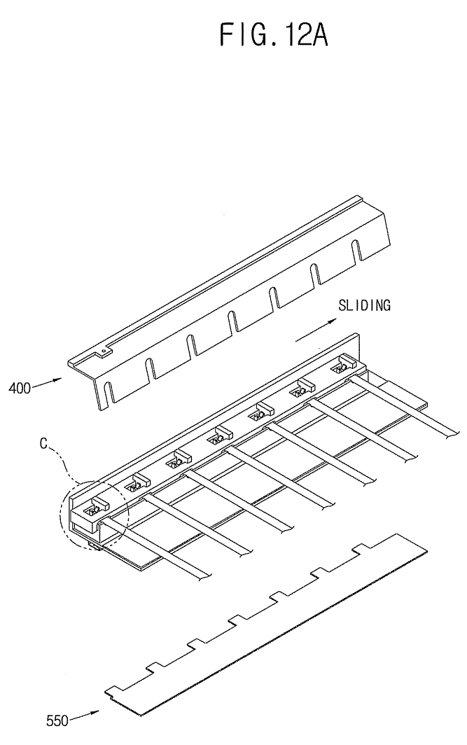

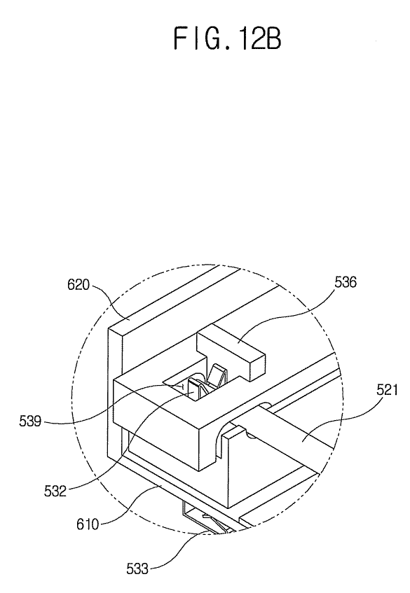

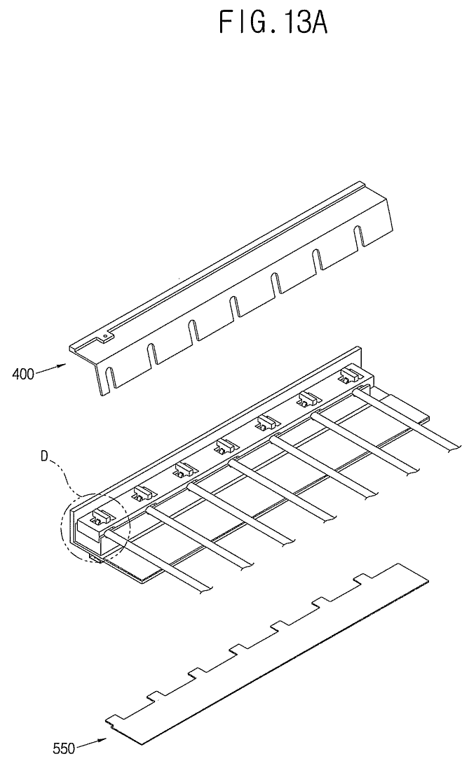

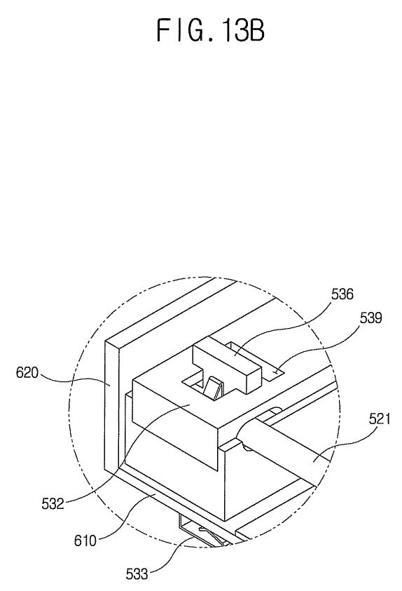

Hereinafter, an assembling method of the backlight unit 500 according to an exemplary embodiment of the present invention will be described with reference to FIGS. 8 through 15, where FIG. 8B is an enlarged view of a portion ‘A’ in FIG. 8A, FIG. 11B is an enlarged view of a portion ‘B’ in FIG. 11A, FIG. 12B is an enlarged view of a portion ‘C’ in FIG. 12A, and FIG. 13B is an enlarged view of a portion ‘D’ in FIG. 13A.

As illustrated in FIGS. 8A and 8B, first, the clamp 531 is inserted into the insertion unit 535 of the socket main body 534. Accordingly, the light source support unit 532 is disclosed on the front surface of the socket main body 534, and the inverter coupling unit 533 is disclosed on the rear surface of the socket main body 534.

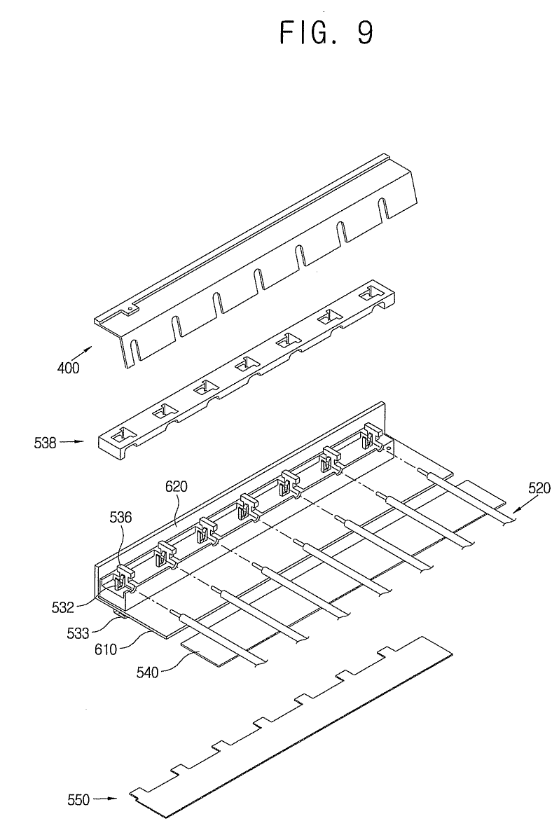

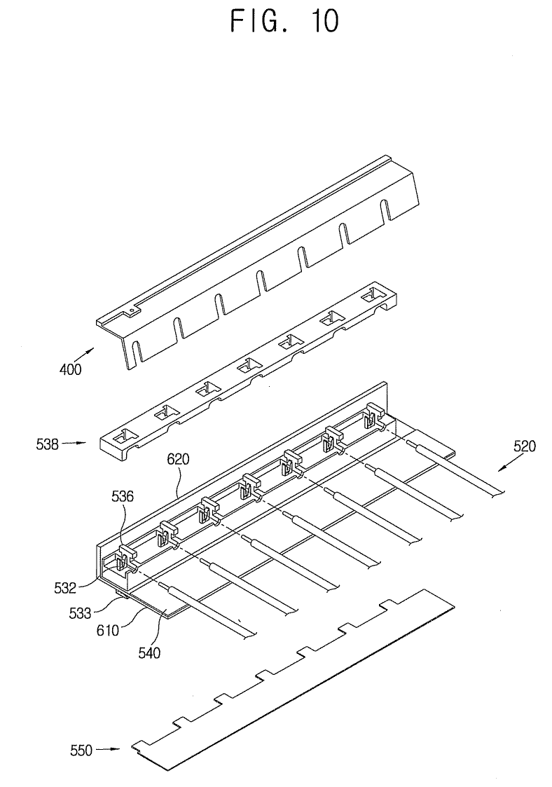

As illustrated in FIG. 9, the accommodation casing 600 is coupled to the socket main body 534. The hook unit 537 of the socket main body 534 is coupled to the coupling hole 630 of the accommodation casing 600. The inverter coupling unit 533 of the clamp 531 is disclosed to a rear side of the accommodation casing 600 by the coupling unit disclosure hole 640.

As illustrated in FIG. 10, the reflection sheet 540 is positioned on the bottom unit 610 of the accommodation casing 600. The socket unit 530 covers an end portion of the bottom unit 610. The reflection sheet 540 covers the remaining portion of the bottom unit 610 that is not covered by the socket unit 530.

As illustrated in FIGS. 11A and 11B, the light source unit 520 is coupled to the socket unit 530 so that the light source electrode 522 of the light source unit 520 rests on the light source support unit 532.

As illustrated in FIGS. 12A and 12B, the socket main body 534 is coupled to the socket locker 538 such that the coupling protrusion 536 of the socket main body 534 can be inserted into the opening unit 539 of the socket locker 538. A position where the coupling protrusion is inserted into the opening unit 539 is referred to as the insertion position (shown in FIG. 5).

As illustrated in FIGS. 13A and 13B, the coupling protrusion 536 is disposed in the second opening unit 539b of the opening unit 539 by allowing the socket locker 538 to slide (e.g., in a direction as shown in FIG. 12A) with respect to the socket main body 534. Accordingly, the socket locker 538 is disposed in a coupling position (shown in FIG. 6) such that the socket locker 538 is prevented from vertical separation from the socket main body 538.

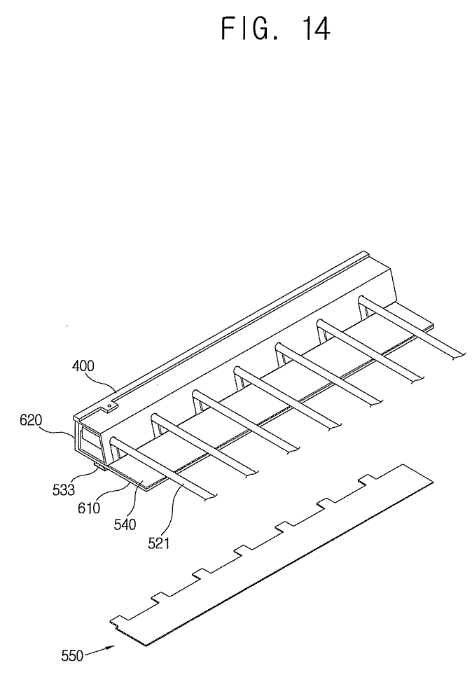

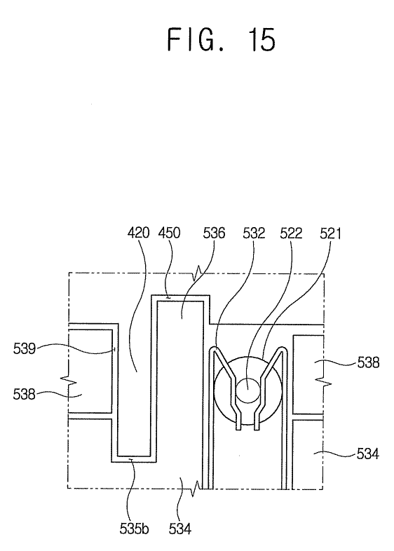

When the socket unit 530 is completely assembled, as illustrated in FIGS. 14 and 15, the side mold 400 is coupled to the socket unit 530 so that the support protrusion 420 can be inserted into the opening unit 539 of the socket locker 538 and the first insertion hole 535b of the socket main body 534. The head part of the coupling protrusion 536 of the socket main body 534 is partially accommodated into coupling protrusion insertion hole 450 of the side mold 400.

In an above-described configuration, as illustrated in FIG. 15, the socket locker 538 is able to move only in an opposite direction of the sliding direction as shown, e.g., in FIG. 12A. Further, the support protrusion 420 inserted into the opening unit 539 presses the coupling protrusion 536 toward an opposite direction of sliding direction of the socket locker 538. Accordingly, the light source support unit 532 is stably coupled to the light source electrode 522.

As illustrated in FIG. 7, the inverter 550 is coupled to the inverter coupling unit 533, and the case 700 envelops a region that couples the inverter 550 with the inverter coupling unit 533.

According to the exemplary embodiments of the present invention, the backlight unit 500 can be integrally assembled with a plurality of light source units 520 by a socket unit 530. Further, the stability of assembling the backlight unit 500 can be improved by fixably coupling elements thereof with each other, including an assembly between the opening unit 539 and the coupling protrusion 536 of the socket locker 538, and another assembly between the opening unit 539 of the socket locker 538 and the support protrusion 420 of the side mold 400.

As apparent from the above description, according to the present invention, there are provided a backlight unit with an improved structure for assembly and assembling stability, a liquid crystal display device having the same, and a method of assembling the backlight unit.

Although the exemplary embodiments of the present invention have been shown and described, it will be appreciated by those skilled in the art that the present invention should not be limited to these exemplary embodiments but various changes and modifications may be made by one of ordinary skill in the art without departing from the principles and spirit of the invention, the scope of which is defined in the appended claims and their equivalents.

What is claimed is:

1. A liquid crystal display device, comprising:
a liquid crystal panel;
a light source unit disposed behind the liquid crystal panel;
a socket unit into which an end portion of the light source unit is inserted; and
an accommodation casing accommodating the light source unit and the socket unit, the socket unit comprising:
a clamp including a light source support unit supporting a light source electrode of the light source unit;
a socket main body coupled to the accommodation casing, the socket main body including a plurality of insertion holes accommodating the clamp, and a coupling protrusion disposed on a surface of the socket main body facing the liquid crystal panel and located between the insertion holes; and
a socket locker comprising an opening unit that provides an insertion position where the coupling protrusion is inserted into the opening unit and a coupling position where the socket locker is coupled to the socket main body by allowing the coupling protrusion to slide from the insertion position with respect to the socket main body.

2. The liquid crystal display device according to claim 1, wherein the opening unit comprises a first opening which defines the insertion position and a second opening which defines the coupling position and is narrower than the first opening, and
wherein the socket locker is coupled to the socket main body by sliding the socket locker in a horizontal direction toward the second opening of the opening unit and away from the insertion position, until the coupling protrusion rests on a portion of the second opening.

3. The liquid crystal display device according to claim 1, wherein the clamp comprises an inverter coupling unit extending from the light source support unit and disposed in the insertion hole facing the accommodation casing.

4. The liquid crystal display device according to claim 3, wherein the inverter coupling unit has an ‘L’ shape.

5. The liquid crystal display device according to claim 4, further comprising an inverter disposed behind the accommodation casing;
wherein the inverter coupling unit is coupled to the inverter.

6. The liquid crystal display device according to claim 5, wherein the inverter comprises a contact unit protruded therefrom and contacting the inverter coupling unit;
wherein the contact unit is inserted between the inverter coupling unit and a rear surface of the socket main body.

7. The liquid crystal display device according to claim 6, further comprising a case covering the inverter coupling unit and the contact unit, the case comprising an opening formed on a region thereof into which the contact unit is inserted.

8. The liquid crystal display device according to claim 3, wherein the socket main body further comprises a hook unit disposed on a surface facing the accommodation casing and located between the insertion holes.

9. The liquid crystal display device according to claim 8, wherein the accommodation casing comprises a coupling hole coupled to the hook unit, and a coupling unit disclosure hole disclosing a portion of the inverter coupling unit when the accommodation casing is coupled to the hook unit.

10. The liquid crystal display device according to claim 8, wherein the coupling protrusion of the socket main body has a ‘T’ shape.

11. The liquid crystal display device according to claim 10, wherein the opening unit of the socket locker has a ‘T’ shape when viewed from a sliding direction.

12. The liquid crystal display device according to claim 1, further comprising a side mold disposed between the liquid crystal panel and the socket unit and covering the socket unit, the side mold comprising a support protrusion inserted into the opening unit in the coupling position and supporting the coupling protrusion of the socket locker.

13. The liquid crystal display device according to claim 12, wherein the support protrusion presses the coupling protrusion in an opposite direction of a sliding direction of the socket locker in the coupling position, and prevents the light source unit from being separated from the light source support unit.

14. The liquid crystal display device according to claim 12, wherein the side mold comprises an accommodation hole into which an end portion of the light source unit is accommodated.

15. The liquid crystal display device according to claim 1, wherein the light source unit comprises at least one of a cold cathode fluorescent lamp, an external electrode fluorescent lamp, and a hot cathode fluorescent lamp.

16. A backlight unit, comprising:
a light source unit;
a socket unit into which an end portion of the light source unit is inserted; and
an inverter supplying power to the light source unit through the socket unit, the socket unit comprising:
a plurality of clamps including light source support units supporting a light source electrode of the light source unit;
a socket main body comprising a plurality of insertion holes into which the respective clamps are inserted, the socket main body extending lengthwise along an end portion of the light source unit; and
a socket locker extending parallel with the socket main body, the socket locker coupled to the socket main body, preventing the light source unit from moving in an inserting direction of the clamps.

17. The backlight unit according to claim 16, wherein the socket main body further comprises a coupling protrusion disposed between the insertion holes, the socket locker comprising an opening unit that provides an insertion position defined by a first opening in the opening unit into which the coupling protrusion is inserted, and a coupling position defined by a second opening in the opening unit that is narrower than the first opening and by which the socket locker is coupled to the socket main body;
wherein the socket locker is coupled to the socket main body by sliding the socket locker in a horizontal direction toward the second opening of the opening unit and away from the insertion position until the coupling protrusion rests on a portion of the second opening.

18. The backlight unit according to claim 17, wherein the clamp further comprises an inverter coupling unit extending from the light source support unit and disposed in the insertion hole facing the accommodation casing.

19. The backlight unit according to claim 18, wherein the inverter coupling unit has an ‘L’ shape.

20. The backlight unit according to claim 19, wherein the inverter comprises a contact unit protruded therefrom and contacting the inverter coupling unit;
wherein the contact unit is inserted between the inverter coupling unit and the socket main body.

21. The backlight unit according to claim 18, wherein the coupling protrusion of the socket main body has a ‘T’ shape.

22. The backlight unit according to claim 21, wherein the opening unit of the socket locker has a ‘T’ shape when viewed from a sliding direction.

23. The backlight unit according to claim 16, wherein the light source unit comprises at least one of a cold cathode fluorescent lamp, an external electrode fluorescent lamp, and a hot cathode fluorescent lamp.

24. A method of assembling a backlight assembly with improved assembling stability, the method comprising:
inserting an end portion of a light source unit into a socket unit, the socket unit comprising:
a plurality of clamps including light source support units for supporting light source electrodes of the light source unit;
a socket main body; and
a socket locker; the method further comprising:
inserting the clamps into respective plurality of insertion holes on the socket main body, the socket main body extending lengthwise along an end portion of the light source unit; and
coupling the socket locker with the socket main body, the socket locker extending parallel with the socket main body and preventing the light source unit from moving in an inserting direction of the clamps.
